(19) United States
(12) Patent Application Publication
(10) Pub. No.: US 2020/0309191 A1
(43) Pub. Date: Oct. 1, 2020

(54) GAS DYNAMIC PRESSURE BEARING, MOTOR, AND FAN MOTOR

(71) Applicant: Nidec Corporation, Kyoto (JP)

(72) Inventors: Kazuhiko FUKUSHIMA, Kyoto (JP); Takehito TAMAOKA, Kyoto (JP)

(21) Appl. No.: 16/787,439

(22) Filed: Feb. 11, 2020

(30) Foreign Application Priority Data
Mar. 29, 2019 (JP) 2019-066217
Jul. 31, 2019 (JP) 2019-141391

(51) Int. Cl. F16C 32/04; F16C 17/02

(52) U.S. Cl. CPC F16C 32/0402; F16C 17/026

(57) ABSTRACT

A rotating-side magnet has a tubular shape extending in an axial direction and has different magnetic poles in the axial direction. A fixed-side magnet has a tubular shape extending in the axial direction, opposes the rotating-side magnet with a gap in the radial direction, and has magnetic poles radially different from the magnetic poles of the rotating-side magnet. Fixed-side auxiliary members each of which is made of a ferromagnetic material are provided at both axial ends of the fixed-side magnet.

### CROSS REFERENCE TO RELATED APPLICATION

The present disclosure claims priority under 35 U.S.C. § 119 to Japanese Application No. 2019-066217 filed on Mar. 29, 2019 and Japanese Application No. 2019-141391 filed on Jul. 31, 2019, the entire contents of each application being hereby incorporated herein by reference.

### 1. FIELD OF THE DISCLOSURE

The present disclosure relates to a gas dynamic pressure bearing, a motor including the gas dynamic pressure bearing, and a fan motor including the motor and an impeller.

### 2. BACKGROUND

Conventionally, a motor using a gas dynamic pressure bearing has been known. A rotating member of the motor is rotatably supported with respect to a stationary member via the gas dynamic pressure bearing. A minute gap is provided between the rotating member and the stationary member in a portion where the gas dynamic pressure bearing is formed. In addition, a dynamic pressure generating groove is provided on a surface forming the gap of at least one of the rotating member and the stationary member. Furthermore, a thrust bearing that supports the rotating member of the motor in a thrust direction with respect to the stationary member is provided. The rotating member of the motor is supported in the thrust direction by a magnet of the thrust bearing.

In the conventional motor, there is disclosed a dynamic pressure gas bearing device having a structure in which a thrust bearing that supports a hub in a thrust direction is provided between an outer circumferential side surface of a flange portion and a hub inner surface opposing the outer circumferential side surface of the flange portion. However, when the above-described structure in which the thrust bearing is arranged in a limited space near the bearing is applied, there is a possibility that it is difficult to secure a space to dispose a magnet for the thrust bearing or a magnetic force capable of supporting a load in the thrust direction.

### SUMMARY

An example embodiment of the present disclosure is a dynamic pressure bearing including a shaft rotatable about a central axis and including a shaft dynamic pressure portion, a sleeve including a sleeve dynamic pressure portion that opposes the shaft dynamic pressure portion via a gap in a radial direction, and a thrust bearing portion, which is capable of being axially positioned by a rotating-side magnet supported by the shaft and a fixed-side magnet supported by the sleeve, on one axial side of the gas dynamic pressure bearing. The rotating-side magnet has a tubular shape extending in an axial direction and has different magnetic poles in the axial direction. The fixed-side magnet has a tubular shape extending in the axial direction, opposes the rotating-side magnet with a gap in the radial direction, and has magnetic poles radially different from the magnetic poles of the rotating-side magnet. Fixed-side auxiliary members each of which is made of a ferromagnetic material are provided on both axial ends of the fixed-side magnet.

A motor according to another example embodiment of the present disclosure includes the gas dynamic pressure bearing, a rotor that rotates integrally with the shaft, and a stator integrated with the sleeve.

An axial fan motor according to another example embodiment of the present disclosure includes an impeller that includes blades rotating integrally with the rotor, and a housing integrated with the stator.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal cross-sectional view of a fan motor according to a first example embodiment of the present disclosure.

FIG. 2 is a longitudinal cross-sectional view of a sleeve according to the first example embodiment of the present disclosure.

FIG. 3 is a longitudinal cross-sectional view of a thrust bearing portion according to the first example embodiment of the present disclosure.

FIG. 4 is a longitudinal cross-sectional view of a thrust bearing portion according to a modification of an example embodiment of the present disclosure.

FIG. 5 is a longitudinal cross-sectional view of a thrust bearing portion according to another modification of an example embodiment of the present disclosure.

FIG. 6 is a longitudinal cross-sectional view of a thrust bearing portion according to still another modification of an example embodiment of the present disclosure.

### DETAILED DESCRIPTION

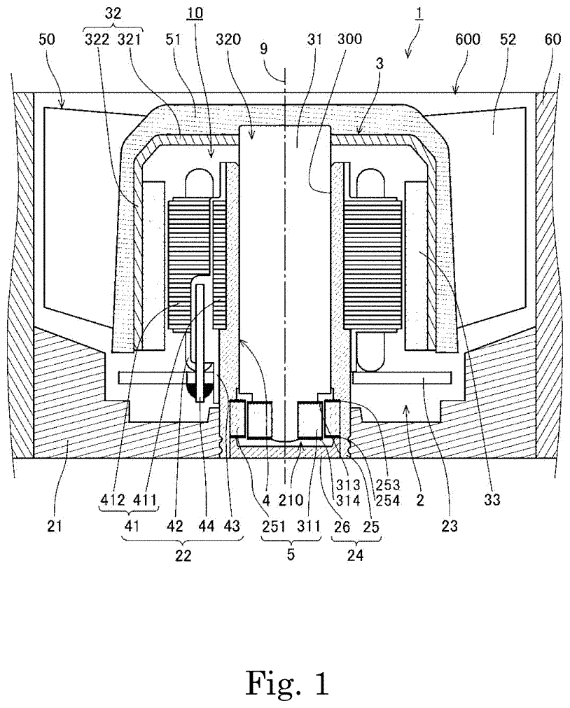

Hereinafter, example embodiments of the present disclosure will be described with reference to the drawings. Note that, in the present application, a direction parallel to a central axis of a motor to be described later is referred to as an “axial direction”, a direction orthogonal to the central axis of the motor is referred to as a “radial direction”, and a direction along an arc about the central axis of the motor as the center is referred to as a “circumferential direction”. In addition, in the present application, the axial direction is also referred to as a vertical direction to describe the shapes or relative positions of each part, a rotating portion side being the upper side with respect to a base member to be described later. However, there is no intention to limit the direction at the time of manufacture and use of the motor and a fan motor according to the disclosure by this definition of the vertical direction. In addition, a “parallel direction” in the present application includes a substantially parallel direction. In addition, an “orthogonal direction” in the present application includes a substantially orthogonal direction. In addition, one axial side indicates the lower side in FIG. 1, and the other axial side indicates the upper side in FIG. 1.

A fan motor 1 according to a first example embodiment of the present disclosure is mounted, for example, inside a casing of a personal computer, and is used as a device that supplies airflow for cooling. However, the fan motor 1 may be used as a device that supplies a cooling airflow to a space such as a home appliance such as a refrigerator, a high-temperature device such as an in-vehicle headlight, or a server system in which a plurality of electronic devices are arranged. FIG. 1 is a longitudinal cross-sectional view of the fan motor 1 according to the first example embodiment of the present disclosure. As illustrated in FIG. 1, the fan motor 1 has a motor 10, an impeller 50, and a housing 60.

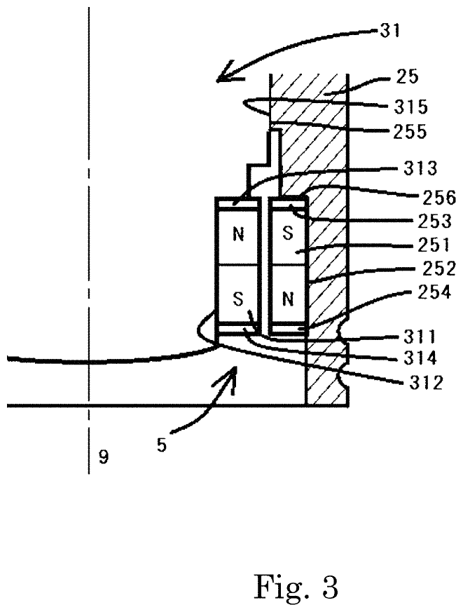

Next, the configuration of the motor 10 will be described. The motor 10 is a device that rotates the impeller 50 according to drive current. As illustrated in FIG. 3, the motor 10 has a stationary portion 2 and a rotating portion 3. The stationary portion 2 is fixed to the housing 60 and is relatively stationary with respect to the housing 60. The rotating portion 3 is supported via a gas dynamic pressure bearing 4, which will be described later, to be rotatable about a central axis 9 extending in the vertical direction, with respect to the stationary portion 2.

The stationary portion 2 has a base member 21, a stator 22, a circuit board 23, and a bearing portion 24.

The base member 21 is a plate-shaped member that expands in the radial direction on one side of the stator 22 and the circuit board 23. As a material of the base member 21, for example, a resin is used. However, metal may be used as the material of the base member 21. The base member 21 has a through-hole 210 that penetrates the base member 21 in the axial direction around the central axis 9. The base member 21 is fixed to the housing 60 to be described later, for example, by screwing. However, the base member 21 may be formed as a single member with the housing 60.

The stator 22 is an armature having a stator core 41, a plurality of coils 42, an insulator 43, and a binding pin 44. The stator 22 is located above at least a part of the base member 21. The stator core 41 is made up of, for example, laminated steel sheets in which electromagnetic steel sheets such as silicon steel sheets are laminated in the axial direction. The stator 22 including the stator core 41 is indirectly supported by the base member 21 by, for example, being directly fixed to an outer circumferential surface of a sleeve 25, which will be described later, with an adhesive. The stator 22 may be indirectly fixed to the outer circumferential surface of the sleeve 25, which will be described later, via another member (not illustrated).

In addition, the stator core 41 includes an annular core back 411 and a plurality of teeth 412 which protrude radially outward from the core back 411. The insulator 43 is used to insulate conductive wires constituting the plurality of coils 42, which will be described later, from the stator core 41. The insulator 43 covers at least a part of the surface of the stator core 41. In addition, the insulator 43 is located on the radially outer side of the sleeve 25 to be described later. As a material of the insulator 43, a resin that is an insulator is used. A detailed configuration of the insulator 43 will be described later. The plurality of coils 42 are an aggregate of conductive wires wound around the plurality of teeth 412 via the insulator 43. The plurality of teeth 412 and the plurality of coils 42 are preferably arranged at substantially equal intervals in an annular shape in a circumferential direction with the central axis 9 as the center.

The circuit board 23 is located on one side of at least a part of the stator 22, and is arranged to be substantially perpendicular to the central axis 9. The circuit board 23 is fixed near one end of the insulator 43 by, for example, welding. The circuit board 23 is electrically connected to the stator 22. An electric circuit configured to supply drive current to the coil 42 is mounted on the circuit board 23. Ends of the conductive wires constituting the coil 42 are electrically connected to the electric circuit of the circuit board 23. The drive current of the motor 10 is supplied to the coil 42 from an external power supply (not illustrated) via the circuit board 23 and the conductive wire.

The binding pin 44 of the stator 22 is used to facilitate connection of the conductive wires constituting the coil 42 to the circuit board 23 and reduce a connection failure. The ends of the conductive wires drawn from the coil 42 are bound to the binding pin 44. One end of the binding pin 44 is electrically connected to the circuit board 23 and fixed to the circuit board 23 by soldering. In addition, the insulator 43 covers a part of an outer circumferential surface of the binding pin 44 in a cylindrical shape. As a result, the binding pin 44 is supported, and it is possible to prevent a withstand voltage failure due to a short circuit between the coil 42 and the binding pin 44 other than the ends of the conductive wires bound to the binding pin 44.

The bearing portion 24 is a portion that rotatably supports a shaft 31 to be described later. For example, metal is used as the material of the bearing portion 24. The bearing portion 24 includes: the sleeve 25 that extends in a cylindrical shape in the axial direction around the shaft 31; a thrust bearing portion 5 that supports the shaft 31 and the sleeve 25 in the thrust direction; and a disk-shaped cap 26 that closes an opening at one end of the sleeve 25; An inner circumferential surface of the sleeve 25 radially opposes an outer circumferential surface of the shaft 31. One side of the sleeve 25 is inserted into the through-hole 210 of the base member 21 and is fixed to the base member 21 by, for example, an adhesive.

A fixed-side magnet 251 is fixed to the thrust bearing portion 5 on one inner circumferential surface side of the sleeve 25 by, for example, an adhesive. The fixed-side magnet 251 is arranged in a tubular shape with the central axis 9 as the center. The inner circumferential surface of the fixed-side magnet 251 serves as a magnetic pole surface in which N poles and S poles are arranged in the axial direction. The inner circumferential surface of the fixed-side magnet 251 opposes an outer circumferential surface of a rotating-side magnet 311, which will be described later, via a gap in the radial direction.

Fixed-side auxiliary members 253 and 254 are fixed to axial end faces of the fixed-side magnet 251 by, for example, an adhesive. The fixed-side auxiliary members 253 and 254 are arranged in an annular shape with the central axis 9 as the center. Inner circumferential surface diameters of the fixed-side auxiliary members 253 and 254 are substantially the same as an inner circumferential surface diameter of the fixed-side magnet 251. In addition, inner circumferential surfaces of the fixed-side auxiliary members 253 and 254 oppose outer circumferential surfaces of rotating-side auxiliary members 313 and 314, which will be described later, via a gap in the radial direction.

The rotating portion 3 has a shaft 31, a rotor hub 32, and a driving magnet 33.

The shaft 31 is a columnar member which is arranged along the central axis 9 and extends in the axial direction. The shaft 31 may be integrated with the rotor hub 32 or may be a separate member. As the material of the shaft 31, for example, metal such as stainless steel is used. An outer circumferential surface of the shaft 31 radially opposes an inner circumferential surface of the sleeve 25 via a slight gap 300. In addition, a diameter of one side of the shaft 31 gradually decreases toward the one side. The rotating-side magnet 311 is fixed to the thrust bearing portion 5, located on the outer circumferential surface side near one end of the shaft 31 by, for example, an adhesive. The rotating-side magnet 311 is arranged in a tubular shape with the central axis 9 as the center. An outer circumferential surface of the rotating-side magnet 311 serves as a magnetic pole surface in which S poles and N poles are arranged in the axial direction. In addition, the outer circumferential surface of the rotating-side magnet 311 radially opposes the inner circumferential surface of the fixed-side magnet 251. Thus, a magnetic force acting between the outer circumferential surface of the rotating-side magnet 311 and the inner circumferential surface of the fixed-side magnet 251 causes the shaft 31 including the rotating-side magnet 311 to be supported by the sleeve 25 including the fixed-side magnet 251 in a non-contact state in the axial direction. As a result, an axial position of the rotating portion 3 when the motor 10 is driven is stabilized.

In addition, the rotating-side auxiliary members 313 and 314 are fixed to axial end faces of the rotating-side magnet 311 by, for example, an adhesive. The rotating-side auxiliary members 313 and 314 are arranged in an annular shape with the central axis 9 as the center. Outer circumferential surface diameters of the rotating-side auxiliary members 313 and 314 are substantially the same as an outer circumferential surface diameter of the rotating-side magnet 311. In addition, outer circumferential surfaces of the rotating-side auxiliary members 313 and 314 oppose the inner circumferential surfaces of the fixed-side auxiliary members 253 and 254 with a gap in the radial direction.

The rotor hub 32 is a member that extends in an annular shape around the shaft 31. The rotor hub 32 has a hub top plate 321 and a hub tubular portion 322. The hub top plate 321 is a portion that is located on the other side of the stator 22 and extends in an annular shape radially outward from the vicinity of the other end of the shaft 31. A hub through-hole 320 penetrating the rotor hub 32 in the axial direction is provided on the radially inner side of the hub top plate 321. A portion near the other end of the shaft 31 is press-fitted into the hub through-hole 320 of the rotor hub 32. As a result, the rotor hub 32 is fixed to the shaft 31 on the other axial side of the insulator 43. However, the shaft 31 and the rotor hub 32 may be fixed to each other by another method such as bonding or shrink fitting. The hub tubular portion 322 is a portion that extends in a substantially cylindrical shape from an outer edge of the hub top plate 321 toward the one side. The hub tubular portion 322 is arranged to be substantially concentric with the central axis 9. An outer circumferential surface of the driving magnet 33 is fixed to an inner circumferential surface of the hub tubular portion 322. Then, the hub tubular portion 322 supports the driving magnet 33. As a material of the rotor hub 32, a magnetic material such as iron is used. As a result, it is possible to suppress a magnetic flux generated from the driving magnet 33 from escaping to the outside.

The driving magnet 33 is fixed to the inner circumferential surface of the hub tubular portion 322 of the rotor hub 32 by, for example, an adhesive. The driving magnet 33 has a substantially cylindrical shape and is located on the radially outer side of the stator 22. An inner circumferential surface of the driving magnet 33 includes north and south poles arranged to alternate with each other in a circumferential direction. In addition, the inner circumferential surface of the driving magnet 33 radially opposes radially outer end faces of the plurality of teeth 412 via a slight gap. That is, the driving magnet 33 has a magnetic pole surface that opposes the stator 22 in the radial direction. However, a plurality of magnets may be used instead of the driving magnet 33 having a substantially cylindrical shape. When the plurality of magnets are used, it is preferable to arrange the magnets on the inner circumferential surface of the hub tubular portion 322 such that magnetic pole surfaces of N poles and magnetic pole surfaces of S poles are alternately arranged in the circumferential direction. Note that the driving magnet 33 may be indirectly fixed to the hub tubular portion 322 via a yoke made of iron.

In the above motor 10, when a drive current is supplied to the coil 42, a magnetic flux is generated in the plurality of teeth 412 which are magnetic cores for the coil 42. In addition, a magnetic circuit passing through the stator 22 and the driving magnet 33 is formed. Then, the magnetic flux acting between the teeth 412 and the driving magnet 33 generates a circumferential torque between the stationary portion 2 and the rotating portion 3. As a result, the rotating portion 3 rotates around the central axis 9 with respect to the stationary portion 2 via the gas dynamic pressure bearing 4 to be described later. In addition, the impeller 50, which will be described later, supported by the rotor hub 32 rotates about the central axis 9 together with the rotating portion 3.

Here, a configuration of the gas dynamic pressure bearing 4 will be described. As described above, the stationary portion 2 including the sleeve 25 and the rotating portion 3 including the shaft 31 oppose each other in the radial direction via the slight gap 300. A gas such as air is interposed in the gap 300. Meanwhile, a gas other than air or a mixed gas of air and a gas other than air may be interposed in the gap 300.

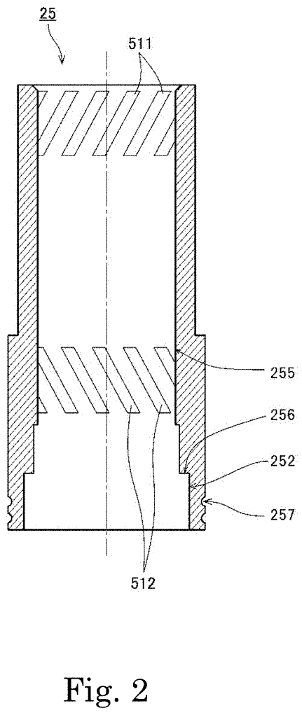

FIG. 2 is a vertical cross-sectional view of the sleeve 25. As illustrated in FIG. 2, the inner circumferential surface of the sleeve 25 includes an upper radial groove array 511 and a lower radial groove array 512. The upper radial groove array 511 and the lower radial groove array 512 are provided at intervals in the axial direction. The upper radial groove array 511 has a plurality of grooves tilted to one side in the circumferential direction toward the one side. The plurality of grooves are arranged in parallel with each other. The lower radial groove array 512 has a plurality of grooves tilted to the one side in the circumferential direction toward the other side. The plurality of grooves are arranged in parallel with each other. Here, the one side in the circumferential direction indicates the left side in FIG. 2 and is the same direction as the rotation direction of the rotating portion 3 of the motor 10. Both the upper radial groove array 511 and the lower radial groove array 512 may be a so-called herringbone-shaped groove array that is tilted to the one side in the circumferential direction toward the center in the axial direction. When the motor 10 is driven, the upper radial groove array 511 and the lower radial groove array 512 induce a dynamic pressure between the upper radial groove array 511 and the lower radial groove array 512 in the axial direction. As a result, a radially supporting force of the shaft 31 with respect to the sleeve 25 is generated.

That is, in the motor 10, the inner circumferential surface of the sleeve 25 and the outer circumferential surface of the shaft 31 radially oppose each other via the gap 300 in which the gas is interposed, thereby constituting a radial bearing portion that is the gas dynamic pressure bearing 4. Note that each of the upper radial groove array 511 and the lower radial groove array 512 is defined in at least one of the inner circumferential surface of the sleeve 25 and the outer circumferential surface of the shaft 31.

As described above, the gas dynamic pressure bearing 4 is constituted by the sleeve 25 in the stationary portion 2, the shaft 31 in the rotating portion 3, and the gas interposed in the gap 300 therebetween. The rotating portion 3 is supported in the radial direction by the gas dynamic pressure bearing 4 and rotates about the central axis 9 in a non-contact state. In addition, the shaft 31 is supported in a non-contact state in the axial direction with respect to the sleeve 25 by the magnetic flux generated between the fixed-side magnet 251 and the rotating-side magnet 311 provided in the thrust bearing portion 5.

Next, configurations of the impeller 50 and the housing 60 will be described.

The impeller 50 includes an impeller cup 51 and a plurality of blades 52. The impeller cup 51 is fixed to the other side surface of the hub top plate 321 of the rotor hub 32 and the outer circumferential surface of the hub tubular portion 322. Each of the blades 52 extends radially outward from the impeller cup 51. The plurality of blades 52 are arranged at substantially equal intervals in the circumferential direction. The impeller cup 51 and the plurality of blades 52 are formed as a continuous member by, for example, injection molding of a resin. However, the impeller cup 51 and the plurality of blades 52 may be formed as separate members made of different materials. The impeller cup 51 and the plurality of blades 52 rotate about the central axis 9 together with the rotating portion 3 of the motor 10.

Note that, as a modification, the impeller 50 may be directly fixed to the shaft 31 without passing through the rotor hub 32. For example, the impeller 50 may include the impeller cup 51 that is fixed to the other end of the shaft 31 and extends in an annular shape around the shaft 31, and the plurality of blades 52 extending radially outward from the impeller cup 51. Further, the impeller 50 may have a structure that supports the driving magnet 33 by fixing the outer circumferential surface of the driving magnet 33 to the inner circumferential surface of the impeller cup 51 via a yoke made of iron.

The housing 60 extends in a tubular shape in the axial direction around the motor 10 and the impeller 50. The housing 60 houses the motor 10 and the impeller 50 radially inward. An outer circumferential surface of the base member 21 of the motor 10 is fixed to an inner circumferential surface on the one side of the housing 60. That is, the base member 21 of the motor 10 forms one side surface of the fan motor 1. A radially inner space of the housing 60 is exposed to the outside via an opening 600 on the other side of the housing 60. An exhaust port (not illustrated) penetrating the base member 21 in the axial direction is provided on the one side of the housing 60.

As the impeller 50 rotates, a gas is sucked in the axial direction into the space inside the housing 60 through the opening 600. In addition, the gas sucked into the housing 60 is accelerated by the impeller 50 and flows through a wind tunnel between the impeller 50 and the housing 60 toward the one axial side. Thereafter, the gas is discharged to the outside of the housing 60 through the exhaust port (not illustrated) of the base member 21.

Subsequently, a detailed configuration of the thrust bearing portion 5 will be described.

FIG. 3 is a longitudinal cross-sectional view of the thrust bearing portion according to the first example embodiment. The thrust bearing portion 5 is a bearing that can be axially positioned on one axial side of the gas dynamic pressure bearing 4 by the rotating-side magnet 311 supported by the shaft 31 and the fixed-side magnet 251 supported by the sleeve 25.

The sleeve 25 includes: a fixed-side magnet support portion 252 that supports the fixed-side magnet 251; a sleeve dynamic pressure portion 255 radially opposes the shaft dynamic pressure portion 315; and a sleeve step 256 that connects the sleeve dynamic pressure portion 255 and the fixed-side magnet support portion 252. That is, the sleeve step 256 is a portion that is substantially perpendicular to the central axis 9 and connects an inner diameter of the sleeve dynamic pressure portion 255 and an inner diameter of the fixed-side magnet support portion 252.

The inner diameter of the sleeve dynamic pressure portion 255 is smaller than the inner diameter of the fixed-side magnet support portion 252. In addition, the fixed-side magnet 251 has a larger inner diameter than the rotating-side magnet 311 to be described later. Therefore, the magnetic force of the fixed-side magnet 251 can be increased by increasing the outer diameter of the fixed-side magnet 251 supported by the inner diameter of the fixed-side magnet support portion 252.

The fixed-side magnet 251 has a tubular shape extending in the axial direction, and has different magnetic poles in the axial direction. In addition, the fixed-side magnet 251 opposes the rotating-side magnet 311 via a gap in the radial direction. At least one magnetic pole of the fixed-side magnet 251 opposes at least one magnetic pole of the rotating-side magnet 311 as radially different magnetic poles. Further, the fixed-side auxiliary members 253 and 254 each of which is made of a ferromagnetic material are provided at both axial ends of the fixed-side magnet 251.

The fixed-side auxiliary members 253 and 254 can easily obtain high coaxiality with the sleeve 25 by radially fitting with the fixed-side magnet support portion 252. The material of the fixed-side auxiliary members 253 and 254 is desirably a ferromagnetic material such as iron, cobalt, and nickel.

When assembling the sleeve 25 and the fixed-side magnet 251, an adhesive is applied to an inner circumferential surface of the fixed-side magnet support portion 252. Next, the fixed-side auxiliary member 253 is inserted, the fixed-side magnet 251 is inserted, and the fixed-side auxiliary member 254 is inserted. Further, the cap 26 to be described later is inserted, and the adhesive is cured. After assembling the fixed-side magnet 251 and the two fixed-side auxiliary members 253 and 254, the resultant may be inserted and bonded or press-fitted into the fixed-side magnet support portion 252. Various fixing methods such as press-fitting, bonding, and caulking can be selected. In addition, the fixed-side auxiliary members 253 and 254 may be fixed to the fixed-side magnet 251 by a magnetic force.

The bearing portion 24 has the cap 26 that covers the opening on one axial side of the sleeve 25. One axial end face of the fixed-side auxiliary member 254 is in axial contact with the other axial side of the cap 26. In this manner, it is possible to prevent foreign matter from entering opposing surfaces of the fixed-side auxiliary members 253 and 254 and the rotating-side auxiliary members 313 and 314 or the like from the one axial side.

The sleeve step 256 connects the sleeve dynamic pressure portion 255 and the fixed-side magnet support portion 252. The inner diameter of the sleeve dynamic pressure portion 255 is smaller than the inner diameter of the fixed-side magnet support portion 252. Therefore, the fixed-side auxiliary members 253 and 254 can be inserted into the fixed-side magnet support portion 252 to position in the axial direction with respect to the sleeve step 256. The fixed-side magnet 251 is supported between the cap 26 and the sleeve step 256 via the fixed-side auxiliary members 253 and 254. Therefore, the fixed-side magnet 251 can be supported by the fixed-side magnet support portion 252, the sleeve step 256, and the cap 26, and thus, can easily fit in the correct position in both the radial direction and the axial direction. In addition, an axial position of the cap 26 can be determined based on a length from the sleeve step 256 and lengths of the fixed-side auxiliary members 253 and 254 and the fixed-side magnet 251, and thus, the assembly can be easily performed.

In addition, a radially outer surface of the cap 26 is radially fitted to a radially inner surface of the sleeve 25. Thus, the fixed-side magnet 251 can be more securely fixed in the axial direction by a coupling force between the cap 26 and the sleeve 25. The radially inner surface of the sleeve 25 fitted to the radially outer surface of the cap 26 has the same inner diameter as the fixed-side magnet support portion 252, but may have a different inner diameter.

The shaft 31 includes a rotating-side magnet support portion 312 on which the rotating-side magnet 311 is supported, and the shaft dynamic pressure portion 315 having an outer diameter larger than an outer diameter of the rotating-side magnet support portion 312. The shaft dynamic pressure portion 315 is a part of the outer circumferential surface of the shaft 31 and radially opposes the inner circumferential surface of the sleeve 25 via the gap 300 in which the gas is interposed. In other words, the shaft dynamic pressure portion 315 is a portion where the radial bearing portion that is the gas dynamic pressure bearing 4 is formed. A part of the shaft dynamic pressure portion 315 radially opposes the upper radial groove array 511 and the lower radial groove array 512 via the gap 300 in which the gas is interposed.

The rotating-side magnet 311 has a tubular shape extending in an axial direction and has different magnetic poles in the axial direction. In addition, the rotating-side magnet 311 opposes the fixed-side magnet 251 via a gap in the radial direction. At least one magnetic pole of the rotating-side magnet 311 opposes at least one magnetic pole of the fixed-side magnet 251 as radially different magnetic poles. Further, the rotating-side auxiliary members 313 and 314 each of which is made of a ferromagnetic material are provided at both axial ends of the rotating-side magnet 311.

The rotating-side auxiliary members 313 and 314 can easily obtain high coaxiality with the shaft 31 by radially fitting with the rotating-side magnet support portion 312. The material of the rotating-side auxiliary members 313 and 314 is desirably a ferromagnetic material such as iron, cobalt, and nickel. In the case of iron, various methods such as press-fitting, bonding, and caulking can be selected as a method of fixing the iron to the shaft 31. Further, the rotating-side auxiliary members 313 and 314 may be fixed to the rotating-side magnet 311 by bonding or the like.

The shaft dynamic pressure portion 315 opposes the inner diameter of the sleeve dynamic pressure portion 255 via the slight gap 300 to form the gas dynamic pressure bearing 4. Therefore, the inner diameter of the sleeve dynamic pressure portion 255 is slightly larger than an outer diameter of the shaft dynamic pressure portion 315. Meanwhile, the outer diameter of the shaft dynamic pressure portion 315 is larger than the outer diameter of the rotating-side magnet 311. Therefore, the assembly is easy since the rotating-side magnet 311 can pass through the inner diameter of the sleeve 25.

From both the axial end faces of the fixed-side magnet 251, a radially outward magnetic flux is generated. This magnetic flux does not directly interfere with the rotating-side magnet 311 arranged radially inward, and does not act as the thrust bearing portion 5. Since the fixed-side auxiliary members 253 and 254 are provided, most of the magnetic flux is directed to the fixed-side magnet 251 and acts as a valid magnetic flux on the thrust bearing portion 5. Therefore, the magnetic force required for the thrust bearing can be obtained in a smaller space.

Similarly, a radially inward magnetic flux is generated from both the axial end faces of the rotating-side magnet 311. The radially inward magnetic flux does not directly interfere with the fixed-side magnet 251 arranged radially outward, and does not act as the thrust bearing portion 5. Since the rotating-side auxiliary members 313 and 314 are provided, the radially inward magnetic flux is reduced, and most of the generated magnetic flux is directed to the fixed-side magnet 251 arranged radially outward, and acts as a valid magnetic flux on the thrust bearing portion 5. Therefore, the magnetic force required for the thrust bearing can be obtained in a smaller space.

It is desirable that axial lengths of the rotating-side magnet 311 and the fixed-side magnet 251 be equal. If the axial lengths opposing each other in the radial direction are the same, a force in the thrust direction in the returning direction easily acts and the thrust bearing portion 5 is realized when mutual axial positions of the rotating-side magnet 311 and the fixed-side magnet 251 change, and functions as the thrust bearing portion 5.

As illustrated in FIG. 1, a gap between one axial end face of the shaft 31 and the other axial end face of the cap 26 is the narrowest among gaps between the stationary portion 2 and the rotating portion 3 in the axial direction. More specifically, the gap between the one axial end face of the shaft 31 and the other axial end face of the cap 26 is narrower than a gap between one axial end face of the impeller cup 51 and the other axial end face of the circuit board 23. In addition, the gap between the one axial end face of the shaft 31 and the other axial end face of the cap 26 is narrower than a gap between one axial end face of the hub top plate 321 and the other axial end face of the sleeve 25. As a result, even if the stationary portion 2 and the rotating portion 3 approach each other, the shaft 31 and the cap 26 first comes into contact with each other, so that the impeller cup 51 does not come into contact with the stationary portion 2. Therefore, it is possible to prevent the impeller 50 from being distorted.

While the example embodiments of the present disclosure have been described above, the present disclosure is not limited to the example embodiments described above.

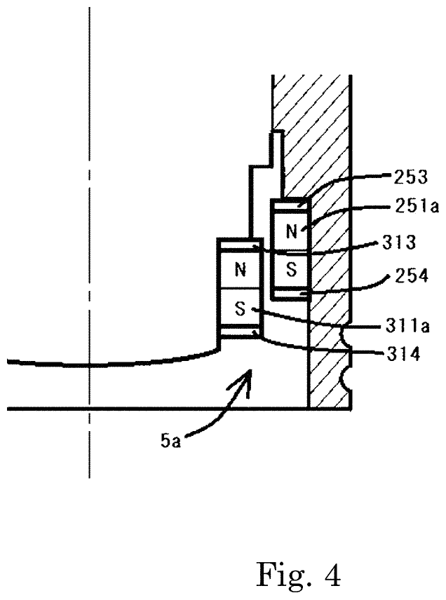

FIG. 4 is a longitudinal cross-sectional view of a thrust bearing portion 5a according to a modification. The thrust bearing portion 5 illustrated in FIG. 3 has a structure in which the magnetic poles of the fixed-side magnet 251 and the magnetic poles of the rotating-side magnet 311 respectively oppose each other in the radial direction. However, not all magnetic poles need to oppose each other in the radial direction. For example, FIG. 4 illustrates a structure in which one magnetic pole of a fixed-side magnet 251a and one magnetic pole of a rotating-side magnet 311a oppose each other in the radial direction. More specifically, the fixed-side magnet 251a has magnetic poles of an N pole and an S pole from the other axial side. In addition, the rotating-side magnet 311a has magnetic poles of an N pole and an S pole from the other axial side. The S pole of the fixed-side magnet 251a and the N pole of the rotating-side magnet 311a oppose each other in the radial direction.

When the fixed-side auxiliary members 253a and 254a and the rotating-side auxiliary members 313a and 314a disclosed in the present example embodiment are used as described above, it is possible to provide a structure in which the thrust bearing portion 5a can secure a magnetic force capable of supporting a load in the thrust direction while securing a space to dispose a magnet of the thrust bearing portion 5a and a bearing space to support a rotating portion.

In addition, it is possible to determine the configuration of the thrust bearing portion according to the magnitude and direction of a thrust load in a case where a rotation direction has been set, in a motor in which the direction and magnitude of a thrust load differs depending on a rotation direction, or in a thrust bearing that supports a gas dynamic pressure bearing of a fan motor.

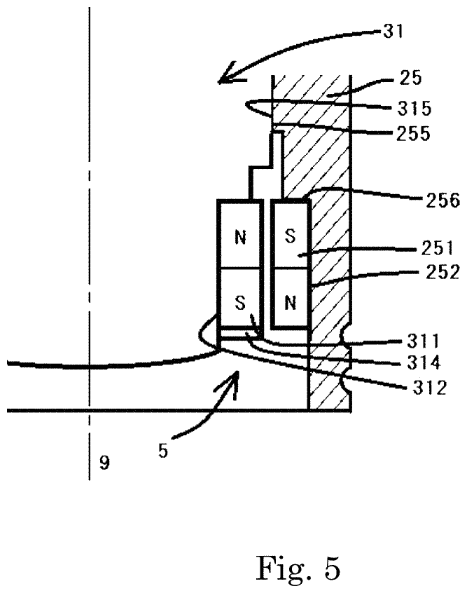

FIG. 5 is a longitudinal cross-sectional view of a thrust bearing portion according to another modification. Note that the contents common to those of the above example embodiment will not be described.

In FIG. 5, the rotating-side auxiliary member 314 made of a ferromagnetic material is provided only at one axial end of the rotating-side magnet 311. That is, the rotating-side auxiliary member 313 is not arranged at the other axial end of the rotating-side magnet 311. In addition, the fixed-side auxiliary members 253 and 254 are not arranged at both the axial ends of the fixed-side magnet 251. In other words, the other axial end face of the rotating-side magnet 311 is in direct contact with a step surface of the shaft 31. In addition, the other axial end face of the fixed-side magnet 251 is in direct contact with the sleeve step 256 of the sleeve 25. Note that the one axial end of the fixed-side magnet 251 may come into contact with the cap 26 as illustrated in FIG. 1 or may be exposed.

In the present example embodiment, air flows from the other axial side to the one axial side. That is, the other axial side of the fan motor 1 is the intake side, and the one axial side is the exhaust side. When the fan motor 1 rotates, the impeller 50 is likely to float to the intake side (the other axial side) due to lift if a magnetic force in the thrust bearing portion 5 is small. If the floating amount of the impeller 50 is large, there may be a problem that the impeller 50 jumps out of the housing 60. Further, there may be a problem that the influence of component tolerance leads to variations in magnetic force by attaching a large number of auxiliary members so that the impeller 50 is rubbed during rotation.

Therefore, the auxiliary member is arranged only on the one axial side of the rotating-side magnet 311 in the present example embodiment so that the magnet is in direct contact with the shaft and the sleeve, whereby it is possible to suppress the variations in magnetic force caused by the component tolerance of the auxiliary member. Further, one axial side of the magnet is not in contact with the shaft and the sleeve, so that it is easier to attract a magnetic flux. Therefore, the magnetic force required for the thrust bearing portion 5 can be obtained in a smaller space by arranging the auxiliary member only on the one axial side of the rotating-side magnet 311.

Further, a total axial length of the rotating-side magnet 311 and the rotating-side auxiliary member 314 is longer than an axial length of the fixed-side magnet 251. That is, overhanging occurs on the rotating side. As a result, a magnetic flux flowing from the axial end face of the fixed-side magnet 251, which normally becomes a leakage magnetic flux, can be attracted to the rotating side by the rotating-side auxiliary member 314. Therefore, it is possible to increase the magnetic force in the thrust bearing portion 5.

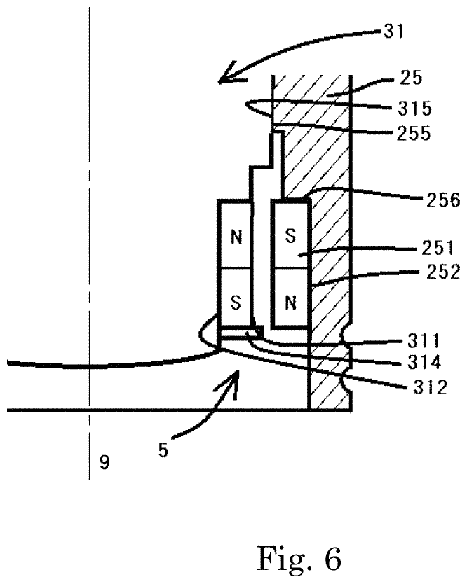

In FIG. 5, a radial length of the rotating-side magnet 311 and a radial length of the rotating-side auxiliary member 314 are the same. Meanwhile, the rotating-side auxiliary member 314 may protrude radially outward from the rotating-side magnet 311 as illustrated in FIG. 6. FIG. 6 is a longitudinal cross-sectional view of a thrust bearing portion according to still another modification. At this time, a wide air gap can be secured between the rotating-side magnet 311 and the fixed-side magnet 251, and variations in magnetic force can be suppressed.

Note that detailed shapes of the gas dynamic pressure bearing, the thrust bearing portion, the motor, and the fan motor may differ from the configurations and the shapes illustrated in the respective drawings of the present application. In addition, the elements that appear in the above-described example embodiments and the modified examples may also be appropriately combined in a range in which there is no contradiction.

For example, only the single fan motor is illustrated in the present example embodiment, but the disclosure is not limited thereto. For example, a serial axial fan in which two fans are arranged in the axial direction may be used. In addition, the two fans may be serial axial reversal-type fans that face different directions.

The present disclosure can be used in a motor and a fan motor.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A gas dynamic pressure bearing comprising:
a shaft rotatable about a central axis and including a shaft dynamic pressure portion;
a sleeve including a sleeve dynamic pressure portion which opposes the shaft dynamic pressure portion via a gap in a radial direction; and
a thrust bearing portion, capable of being axially positioned by a rotating-side magnet supported by the shaft and a fixed-side magnet supported by the sleeve, on one axial side of the gas dynamic pressure bearing; wherein
the rotating-side magnet has a tubular shape extending in an axial direction, and has different magnetic poles in the axial direction;
the fixed-side magnet has a tubular shape extending in the axial direction, opposes the rotating-side magnet via a gap in the radial direction, and has magnetic poles radially different from the magnetic poles of the rotating-side magnet; and
fixed-side auxiliary members each of which is made of a ferromagnetic material are provided at both axial ends of the fixed-side magnet.

2. The gas dynamic pressure bearing according to claim 1, wherein
the sleeve includes a fixed-side magnet support portion that supports the fixed-side magnet; and
an inner diameter of the fixed-side magnet support portion is larger than an inner diameter of the sleeve dynamic pressure portion.

3. The gas dynamic pressure bearing according to claim 2, wherein the fixed-side auxiliary member is radially fitted to the fixed-side magnet support portion.

4. The gas dynamic pressure bearing according to claim 2, wherein
the sleeve includes a sleeve step that connects the sleeve dynamic pressure portion and the fixed-side magnet support portion; and
the sleeve step is in axial contact with the fixed-side auxiliary member.

5. The gas dynamic pressure bearing according to claim 1, further comprising a cap that covers an opening on one axial side of the sleeve; wherein
another axial side of the cap is in axial contact with one axial end surface of the fixed-side auxiliary member.

6. The gas dynamic pressure bearing according to claim 5, wherein a radially outer surface of the cap is radially fitted to a radially inner surface of the sleeve.

7. The gas dynamic pressure bearing according to claim 1, wherein an axial length of the rotating-side magnet is equal to an axial length of the fixed-side magnet.

8. The gas dynamic pressure bearing according to claim 1, wherein rotating-side auxiliary members each of which is made of a ferromagnetic material are provided at both axial ends of the rotating-side magnet.

9. The gas dynamic pressure bearing according to claim 1, wherein
the shaft includes a rotating-side magnet support portion that supports the rotating-side magnet; and
an outer diameter of the rotating-side magnet is smaller than an outer diameter of the shaft dynamic pressure portion.

10. The gas dynamic pressure bearing according to claim 9, wherein the rotating-side auxiliary member is radially fitted to the rotating-side magnet support portion.

11. A motor comprising:
the gas dynamic pressure bearing according to claim 1;
a rotating portion that rotates integrally with the shaft; and
a stationary portion integrated with the sleeve.

12. A fan motor comprising:
the motor according to claim 11;
an impeller including blades that rotate integrally with the rotating portion; and
a housing integrated with the stationary portion.

13. A gas dynamic pressure bearing comprising:
a shaft rotatable about a central axis and including a shaft dynamic pressure portion;
a sleeve including a sleeve dynamic pressure portion which opposes the shaft dynamic pressure portion via a gap in a radial direction; and
a thrust bearing portion, capable of being axially positioned by a rotating-side magnet supported by the shaft and a fixed-side magnet supported by the sleeve, on one axial side of the gas dynamic pressure bearing; wherein
the rotating-side magnet has a tubular shape extending in an axial direction, and has different magnetic poles in the axial direction;
the fixed-side magnet has a tubular shape extending in the axial direction, opposes the rotating-side magnet via a gap in the radial direction, and has magnetic poles radially different from the magnetic poles of the rotating-side magnet; and
a rotating-side auxiliary member made of a ferromagnetic material is provided only at one axial end of the rotating-side magnet.

14. The gas dynamic pressure bearing according to claim 13, wherein a total axial length of the rotating-side magnet and the rotating-side auxiliary member is longer than an axial length of the fixed-side magnet.

15. The gas dynamic pressure bearing according to claim 14, wherein the rotating-side auxiliary member protrudes radially outward from the rotating-side magnet.

16. A motor comprising:
the gas dynamic pressure bearing according to claim 13;
a rotating portion that rotates integrally with the shaft; and
a stationary portion integrated with the sleeve.

17. A fan motor comprising:
the motor according to claim 16;
an impeller including blades that rotate integrally with the rotating portion; and
a housing integrated with the stationary portion.
